(19) United States
(12) Patent Application Publication
(10) Pub. No.: US 2013/0325416 A1
(43) Pub. Date: Dec. 5, 2013

(54) Contribution Model

(71) Applicant: Hamid Benbrahim, Boston, MA (US)

(72) Inventor: Hamid Benbrahim, Boston, MA (US)

(73) Assignee: FMR LLC

(21) Appl. No.: 13/482,068

(22) Filed: May 29, 2012

(51) Int. Cl. G06F 17/10

(52) U.S. Cl. 703/2

(57) ABSTRACT

Contribution-based segmentation classification measures a contribution that an entity provided to a group dynamic. Contribution-based segmentation classification forms a network structure that represents relationships among a set of entities and produces a random partition of the set of entities into a fixed number of groups of entities. For each of a plurality of iterations, contribution-based segmentation classification sequentially associates each entity with each group, and measure a modularity for the network, adds the measured modularity to a vector of modularities for the respective entity using the groups as a base, and compute a distance between each of the entities using the modularity vectors to form clusters of vectors according to the computed distance, and segments the entities according the formed clusters.

### BACKGROUND

This invention relates to computer implemented techniques to establish relationships among entities.

For example, an organization may desire to find relationships among entities such as when conducting a direct marketing campaign. For such a direct marketing campaign, the organization seeks to select the best type of customer to send a promotional offer to and needs to segment a large group of potential customers in groups according to characteristics.

### SUMMARY

According to an aspect of the invention, a computer program product tangible stored on a computer readable storage device for contribution-based segmentation classification includes instructions for causing a processor to form a network structure that represents relationships among a set of entities, produce a random partition of the set of entities into a fixed number of groups of entities, then for each of a plurality of iterations, sequentially associate each entity with each group, and measure modularity for the network, add the measured modularity to a vector of modularities for the respective entity using the groups as a base, compute a distance between each of the entities using the modularity vectors, form clusters of vectors according to the computed distance, and segment the entities according the formed clusters.

According to an additional aspect, a computer implemented method includes forming a network structure that represents relationships among a set of entities, producing a random partition of the set of entities into a fixed number of groups of entities, then for each of a plurality of iterations, sequentially associating each entity with each group, and measuring modularity for the network, adding the measured modularity to a vector of modularities for the respective entity using the groups as a base, computing a distance between each of the entities using the modularity vectors, forming clusters of vectors according to the computed distance, and segmenting the entities according the formed clusters.

According to an additional aspect a computer system includes a processor, memory coupled to the processor, and a computer readable medium storing a computer program product for contribution-based segmentation classification, comprises instructions for causing the processor to form a network structure that represents relationships among a set of entities, produce a random partition of the set of entities into a fixed number of groups of entities, then for each of a plurality of iterations, sequentially associate each entity with each group, and measure modularity for the network, add the measured modularity to a vector of modularities for the respective entity using the groups as a base, compute a distance between each of the entities using the modularity vectors, form clusters of vectors according to the computed distance; and segment the entities according the formed clusters.

The following are within the scope of aspects of the invention.

To form the network structure uses explicit or implicit information of the entities and the distance calculated is the Euclidean distance. The fixed number of groups is based on a desired resolution. A configuration model is used to produce the initial random partition of the entities into the fixed number of groups of entities. Iteratively associate the first entity in the first group with each of the succeeding groups and determine corresponding modularity for the network as the first entity is associated with each of the succeeding groups. To determine modularity includes computing modularity for the network as a function of a number of links within the group compared to a number of links out of the group. The modularity is a maximum when intra group links are at a maximum and inter group links are at a minimum. The computed modularity is added to for an entity to a vector of modularities for the entity using the groups as a base for values in the vector. The modularity is Newman's modularity and a centroid is computed for each computed cluster. The modularity is determined as a sum of links within a group minus an expected number of inner links inside the group minus outer links/degree.

One or more of the aspects may provide one or more of the following advantages.

Contribution-based segmentation seeks to measure an individual entity's contribution to a group dynamic that is, contribution-based segmentation seeks to determine what an entity contributes to a group dynamic or the role that the entity plays within different groups. Contribution-based segmentation provides a tool to classify entities (e.g. people, corporations, etc.) according to such roles in contrast to current methods that classify entities according to entity attributes rather than group impact. The resulting segmentation can be used for a number of business applications such as defining customer segments according to roles the customers play, therefore better understanding customer needs. The techniques could be applied to providing better credit ratings and valuations based on the actual roles corporations play.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a system to determine an individual entity's contribution to a group.

FIG. 2 is a flow chart depicting a contribution-based segmentation process to determine individual entities' contributions to an entity group.

FIG. 3 is a flow chart depicting aspects involved in modularity measurements.

FIGS. 4A-4C are diagrams useful in understanding association.

FIG. 5 is a depiction of vectors.

FIG. 6 is a flow chart depicting a high level view of forming segments from clusters.

FIG. 7 is a flow chart depicting an example of a clustering technique

FIG. 8 is a diagram depicting an exemplarily, diagrammatical example of a segmentation of the entities in FIGS. 4A-4C after a typical execution of contribution-based segmentation software.

FIG. 9 is a diagram depicting an exemplary representation of segments.

### DETAILED DESCRIPTION

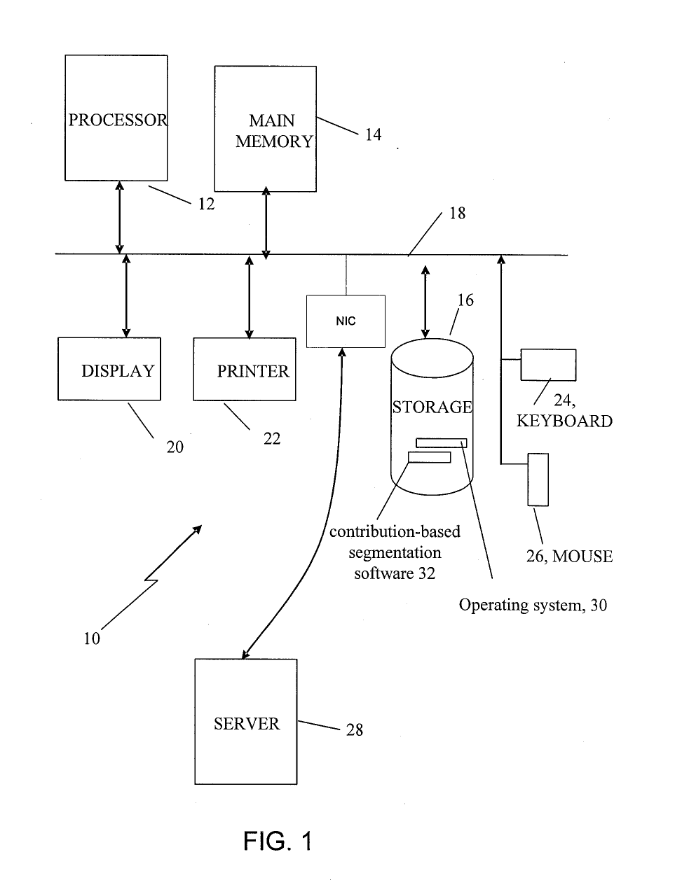

Referring now to FIG. 1, a system to determine an individual entity's contribution to a total group contribution is shown. The system 10 includes a CPU 12, main memory 14 and persistent storage device 16, all coupled via a computer bus 18. The system 10 also includes output devices such as a display 20 and a printer 22, as well as user-input devices such as a keyboard 24 and a mouse 26. Not shown in FIG. 1, but necessarily included in a system of FIG. 1 are software drivers and hardware interfaces to couple all the aforementioned elements to the CPU 12.

The computer system 10 also includes an operating system 30 and contribution-based segmentation software 32 stored in the persistent storage and executed by the processor in memory. The contribution-based segmentation software 32 as stored on a computer readable storage medium provides a computer program product for contribution-based segmentation. The contribution-based segmentation software 32 executes a scalable algorithm that considers different similarities among entities, and which finds an optimal segmentation of entities. The contribution-based segmentation software 32 can render a visual representation of such segmentations on the display 20 or the printer 22 to provide a decision-maker with results or can provide the segmentation results as a file structure or other data structure for use by automated management software 34. The automated management software 34 uses the segmentation results for some purpose, such as direct marketing to customers, analyzing roles businesses play in an economy, analyzing pricing of securities based on reliance of the underlying to certain external factors. The automated management software 34 can be any such software that relies on segmentation of entities into groups.

The contribution-based segmentation software 32 resides on the computer system 10, as shown or may reside on a server 28 that is coupled to the computer system 10, e.g., over a network through a network interface card (NIC) in a conventional client-server arrangement. Databases that supply data to the contribution-based segmentation software 32 can reside on the storage 16 or on a storage device (not shown) associated with server 28 or as networked-based databases that are accessed by the client 10 and/or the server 28, as appropriate and as would be known to one of ordinary skill in the art.

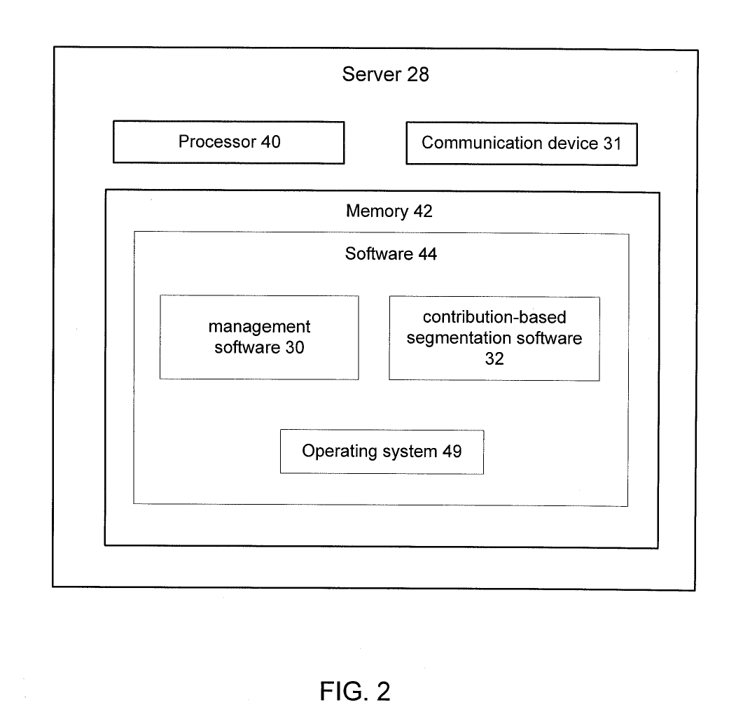

Referring to FIG. 2, a server 28 may be any type of computing device or multiple computing devices. Server 28 includes one or more processor(s) 40 (referred to simply as “processor 40”), a communication device 31, and memory 42 that stores software 44 to be executed by the processor 40. The server 28 also includes storage (not shown). Communication device 31 facilitates communication between the server 28 and clients (such as system 10 (FIG. 1) coupled to a network (e.g., a LAN and/or WAN, such as the Internet)). Software 44 includes the management software 34 that uses segmentations provided from contribution-based segmentation software 32, which may be downloaded from the storage device 16 and run on the server 28. The server 28 also includes an operating system software environment 48 that includes, but that is not necessarily limited to, an operating system 49.

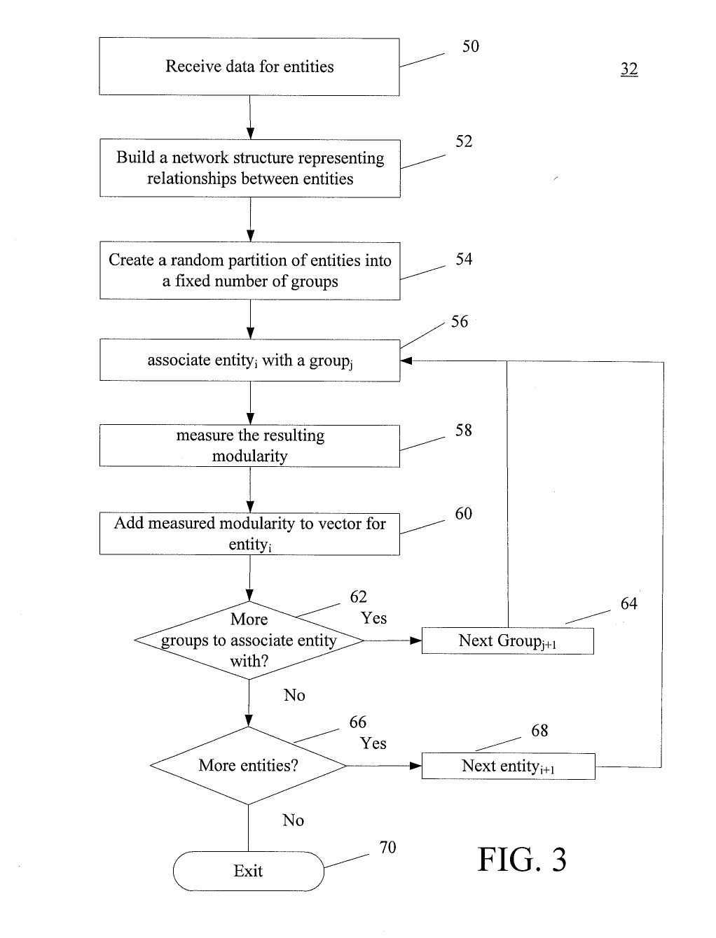

Referring now to FIG. 3, the contribution-based segmentation software 32 receives 50 data from a database. The data includes information regarding entities within a large group of entities (E). The contribution-based segmentation software 32 tries to find measures of similarity among the entities (E). The contribution-based segmentation software 32 builds 52 a network structure that represents relationships between entities (E) in the large group. The relationships are represented using either explicit or implicit information received from the database regarding each individual entity (E). The explicit information can be any information that indicates behaviors of entities in the large group. For example, for a product domain, the information can be what products customers buy. However, the behaviors each customer takes need not necessarily be tied to what similarity the contribution-based segmentation software 32 is trying to measure regarding the entity. Implicit information is assumption based on co-incidental behaviors derived from explicit information, such as assuming that same product purchases provide implicitly that two entities are similar.

This mathematical network structure once formed is partitioned into a fixed number of groups. The number of groups is a function of resolution. For example, the number of groups can be empirically determined by evaluating whether adding a group changes the number of segments.

As an initial partition, the contribution-based segmentation software 32 produces 54 a random partition of the entities (E) into the fixed number of groups (G) of entities. For a first entity (E₁) in a first one of the groups (G₁), a measurement 58 is made of the modularity Q₁ of the network when that entity (E₁) is in the first group (G₁). The measured modularity Q₁ is added to a vector (V₁), as value S₁ for entity (E₁).

The contribution-based segmentation software 32, in an iterative manner, sequentially associates the first entity (E₁) in with each of the succeeding groups (j+1 etc.) and provides corresponding measurements of the resulting network modularities Q for the entity (E₁) in each of the succeeding groups. Thus, continuing with FIG. 3, the contribution-based segmentation software 32 determines if there are more groups (Gⱼ) to associate with entity (Eᵢ), and if so, processes the next group with entity (Gᵢ). Otherwise, the contribution-based segmentation software 32 determines if there are more entities (Eᵢ) to associate with the groups (Gⱼ), and if so processes the next entity (i+1) with groups (1 to j). Otherwise, the process exits.

That is, the contribution-based segmentation software 32 associates an entity (Eᵢ) with a group (Gⱼ), e.g., the first entity with the first group, measures the modularity and moves that entity (Eᵢ) into the second group and measures the modularity of entity (Eᵢ) with all of the members of the second group, and so forth. Each measurement of modality Q is recorded as a vector that has the number of groups corresponding to the number of entries in the vector. With the modality values in the vector determined as a computation of number of links intra group vs. number of links out of the group for whole network. Modularity is max when intra group links are at a maximum, and inter group links are at a minimum. The process adds the measured modularity for each entity to a vector of modularities for the respective entity using the groups as a base. The modularity is a measure of the whole network that changes as contribution-based segmentation software 32 changes partitions. Vector modularity values Q are determined by Newman's modularity, although other modularity techniques can be used.

The modularity is a sum of inner links (links within a group) minus the expected number of inner links inside the group minus outer links/degree. The sum of inner links is the sum of links among the entity within the group to other entities and the sum of outer links is the sum of links among the groups to other entities in other groups and the expected number of links is the number of links of an entity divided by the total number of links in the network. That is, the modularity Q determined for each entity is a fraction of the connections of that entity within the given group minus the expected fraction of connections that assumes the connections were randomly distributed. The value of the modularity Q lies in a range of, e.g., −½ to +1. The modularity is positive if the number of edges within a group exceeds the number expected. For a given division of the network into groups, the modularity reflects the concentration of nodes within groups compared with a random distribution of connections between all entities regardless of the groups.

Several techniques are known for calculating modularity Q. For a division of entities into two groups, group 1 and group 2, the modularity “Q” is defined as the fraction of edges that fall within group 1 or group 2 minus the expected number of edges within group 1 and group 2 for a random graph with same node degree distribution as the network. The expected number of edges can be computed using the concept of configuration models, a randomized realization of a particular network, where for a network with n nodes, with each node nᵢ having a node degree kᵢ, the configuration model cuts each edge into 2 halves, and then each half edge, called a stub, is rewired randomly with any other stub in the network even allowing self-loops. Thus, even though the node degree distribution of the graph remains intact, the configuration model results in a completely random network. Other formulations of modularity can be used.

Modularity compares the number of edges inside a group with the expected number of edges that one would find in the group if the network were a random network with the same number of nodes and where each node keeps its degree, but edges are otherwise randomly attached.

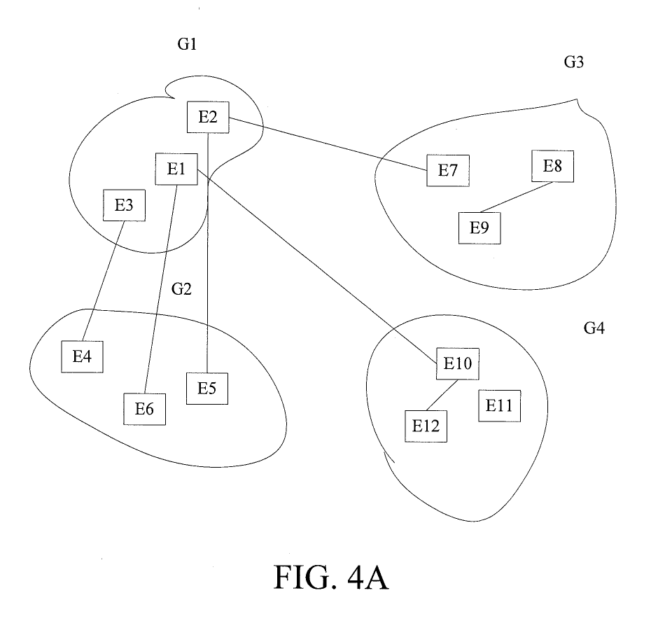

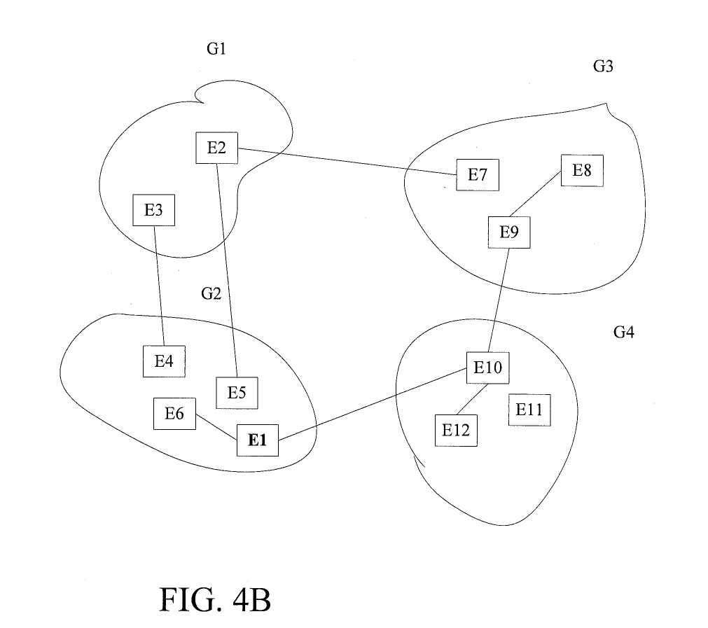

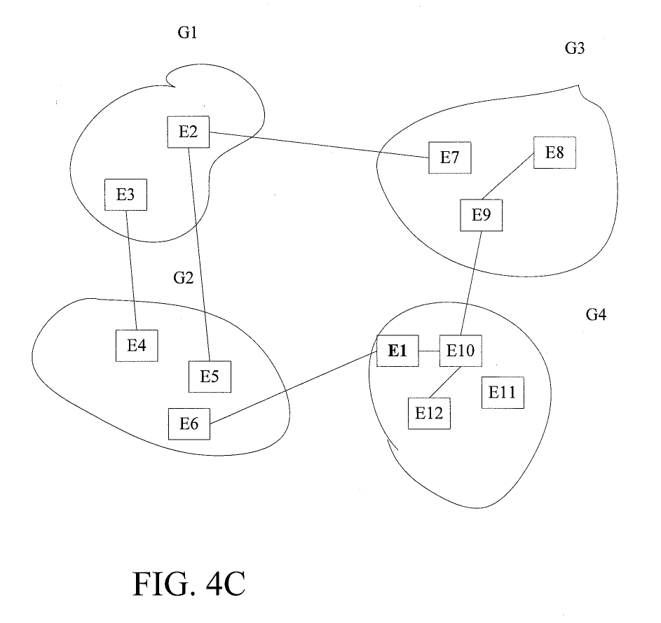

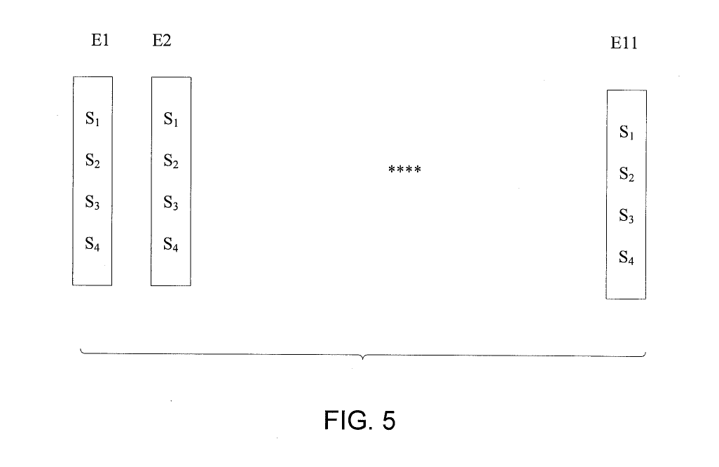

Referring now to FIGS. 4A-4C, a pictorial representation of the foregoing is shown. In FIG. 4A, as an initial partition, an entity 1 (E1) is in group one (G1). Modularity Q₁ is measured and stored, as value S1 in vector V₁ for entity E₁ (FIG. 5). In FIG. 4B, in a subsequent partition, entity 1 (E1) is now in group two (G2). Modularity Q₂ is measured and stored, as value S2 in vector V₁ for entity E₁ (FIG. 5). Similarly, as shown in FIG. 4C, another partition, entity 1 (E1) is in group three (G3). Modularity is measured and stored, as value S3 in vector V₁ for entity E1 (FIG. 5), and so forth.

A non-limiting example, can further illustrate the concept. Assume that the contribution-based segmentation software 32 seeks to measure an individual's contribution to a group dynamic that is, the contribution-based segmentation software 32 determines what an entity E₁ contributes to a group dynamic or the role that the entity E₁ plays within different groups.

In FIGS. 4A-4C with this example, the groups are assumed to be tables of individuals (entities Eᵢ) and measurements are made over a period of time of the level of communication, e.g., conversation, at each of the tables as each of the entities (entities Eᵢ) is moved among each of the tables using the process described above. By moving each of the entities Eᵢ around to each of the tables, here Groups 1-4, conversation levels are measured at each table. The contribution-based segmentation software 32 establishes which of the entities E₁ contribute the most to conversations at the tables and can thus be grouped similarly, which contribute the least and so forth. All of the entities that have similarities are thus segmented similarly or in the same groups.

Referring now to FIG. 5, a pictorial representation of the vectors V is shown for the example of FIGS. 4A-4C. In FIG. 5, there exists a vector for entity 1 (E₁) with modularity values Q for each group, e.g., group one (G₁) to group four (G₄). Similar modularities Q are measured and stored, as values S1-S4 in vector V₂ for entity E₂ and vectors V₃ to V₁₁ are provided for all remaining entities, e.g., E₃ to E₁₁. In FIG. 4B, a subsequent partition, entity 1 (E₁) is now in group two (G₂). Modularity is measured and stored, as value S₂ in vector 1 for entity 1 (FIG. 5). Similarly, as shown in FIG. 4C, another partition, entity 1 (E₁) is in group three (G₃). Modularity is measured and stored, as value S₃ in vector V₁ for entity 1 (FIG. 5), and so forth.

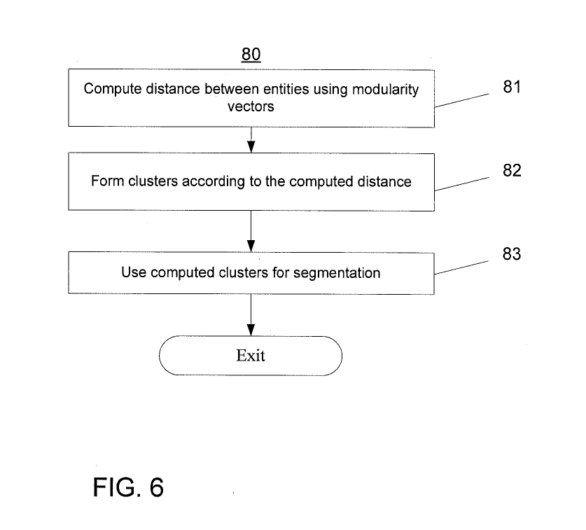

Referring now to FIG. 6, the contribution-based segmentation software 32 computes 81, a Euclidean distance between entities (E) using the modularity vectors. The contribution-based segmentation software 32 measures the distances between vectors, using differences between the square roots of the sum of the squares of the values of a vector. From the distances, clusters of entities (E) are formed 82 using any clustering technique to group the entities together based on the calculated distances. From the formed clusters of vectors V based on the Euclidean distance these clusters are used to segment 83 the entities.

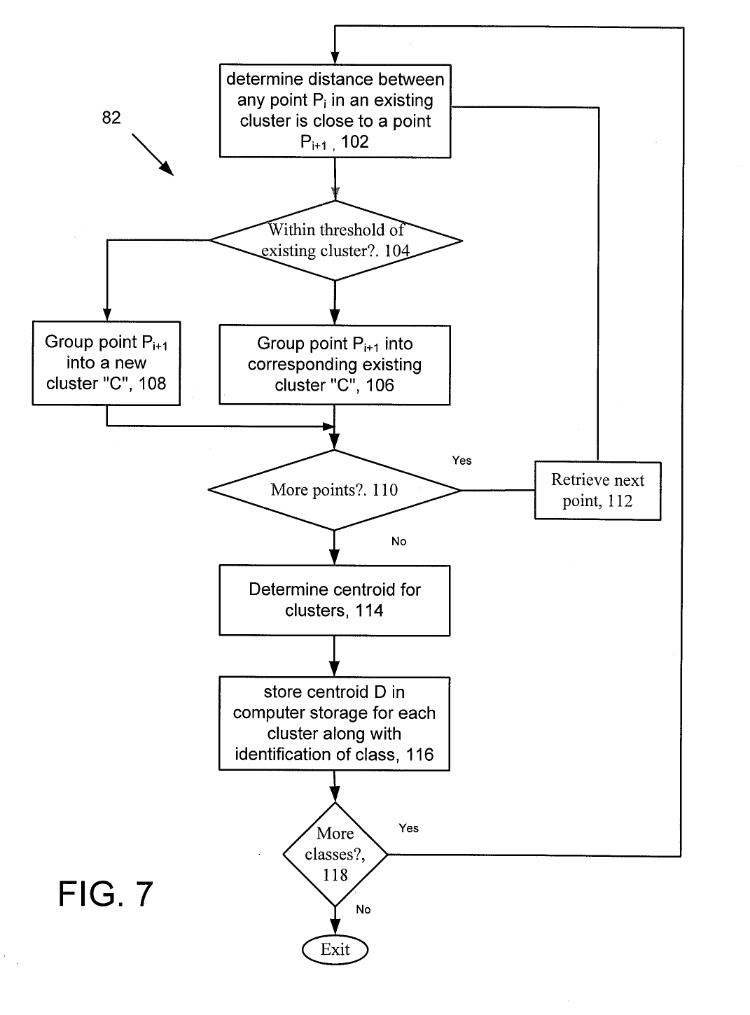

Referring now to FIG. 7, details on a clustering technique 82 are shown. In FIG. 7 “points” as used in this discussion refers to, for example, entities (E), as in the discussion above. For a particular point Pi (entity vector) in N-dimensional space, clustering 82 determines whether that point Pi is close to another point Pi+1 of the same class, by determining the distance between those points as X=Pi+1−Pi+1 in the N-dimensional space and comparing the distance X to a threshold value T.

The clustering algorithm 82 determines the distance X (here in two dimensional space for illustration, but in practice, n-dimensional space) between all of the points, and groups them into the clusters provided that the distance X is less than or equal to the threshold value T. As an example, the clustering algorithm determines 102 the distance X between a point Pi+1 and any point in each existing cluster, compares 104 that distance X to the threshold T and determines whether the point Pi+1 belongs in the existing cluster 106 or whether the point Pi+1 belongs in a new cluster 108. The clustering algorithm determines 110 whether there are more points. If so, the clustering algorithm retrieves 112 the next point and continues processing, as shown.

Optionally, to simplify application of the algorithm to a very large group (but at a potential loss of resolution) for the very large group if a sufficient number of entities have been clustered into a sufficient number of groups so that there are not any more points to cluster, the process finds 114 a centroid for each determined cluster. Finding a centroid involves finding a point that best represents the cluster, e.g., is at the center of the cluster or which is clustered around the predominant number of points in the cluster.

Thus, the clustering algorithm group points into clusters and from the cluster a centroid is found that is used to represent the points and all possible further points in the cluster. The centroid “D,” is the point P in N-dimensional space, which along with a determined tolerance, variance or standard deviation represents that particular cluster. The centroid D is that point in the cluster (either calculated or an actual point) that is at the center of all of the points in the cluster. The centroid point D, along with the determined tolerance, variance or standard deviation and the identification of the class corresponding to the cluster is stored in a database. Thereafter the centroid along with the tolerance could be used to segment new entities or other entities from the very large group.

This approach of using a centroid to represent the data is a compression technique that reduces the amount of processing for very large groups of entities where limited numbers of clusters are needed and where it is acceptable to have many outliers. For any given class of entities should class be also tracked, there is likely to exist several clusters and hence several centroids to represent the class. Outliers can be considered as noise and can be discarded. To form the segments of entities, the entities in each cluster would be considered as a segment and thus those entities in each segment could be considered as similar and marketed to or otherwise treated similarly.

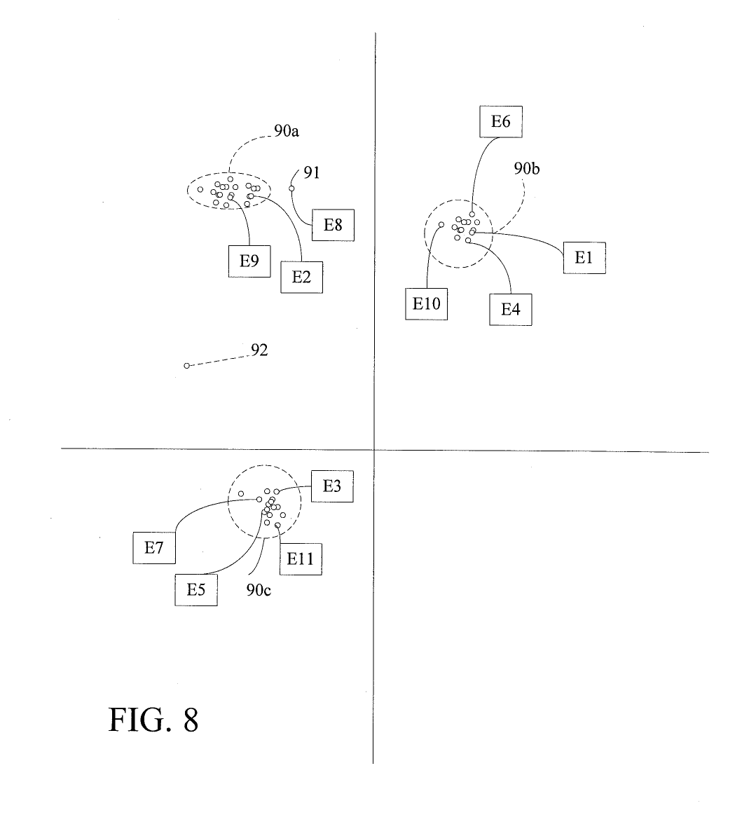

Referring now to FIG. 8, three clusters 90a-90c and two outliers 91 and 92 are shown. In FIG. 8 “points” as used in this discussion refers for example to entities (E), as in the discussion above. In clusters 90a-90c are grouped entities E1 through E7 and E9-E11 (represented by points), along with other entities not specifically mentioned in FIGS. 4A-4C so as to depict here an expanded example.

In cluster 90a are included entities E2 and E9 (along with others not referenced), whereas entity E8 is considered an outlier 91. Similarly, in cluster 90b are included entities E1, E4, E6 and E10 (along with others not referenced) and in cluster 90b are included entities E3, E5, E7 and E11 (along with others not referenced) and there is also another outlier 92 (another non-referenced entity). In this very simplified example in two dimensional space there are three clusters and two outlier points depicted.

In this simplified example, the clusters 90a, 90b and 90c can represent either various classes of entities, or if there is no class distinctions made as in this discussion all classes of entities. The outlier points can be considered as noise in the data, and thus ignored. Accordingly, there can be another requirement for forming clusters, which is that the cluster has a minimum number of members. Generally, that number is determined empirically.

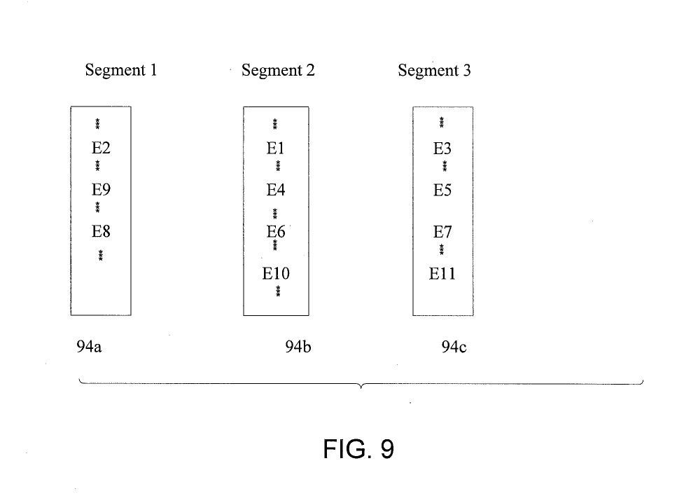

Referring now to FIG. 9, one way to represent the segments is as a list. The segments therefore would be the members of each of the clusters 90a, 90b and 90c and the un-clustered outliers 91 and 92 might in some circumstances be discarded, as not being capable of being grouped (noise).

However, depending on the domain over which the contribution-based segmentation software 32 is operating the outliers could be considered their own cluster and hence segment or otherwise useful. Further, new entities could be clustered in new clusters with the outliers if the new entities had vectors that are sufficiently close to the vectors of the outliers. Entity E1-E11 along with the other entities not specifically referenced from the expanded example are identified in the lists 94a-94c intermingled with the other non-referenced entities. The entities could be ordered according smallest distance in each cluster from the centroid.

Described below is an exemplary use case of customer segmentation based on investment behavior (domain). In the example below, the customer (C) is a specific type of entity (E), as generally mentioned above.

In this use case, contribution-based segmentation software 32 builds the network by collecting data that represent lists of investment transactions for each customer (investments in or withdrawals from a particular fund, for example). In an initial state of the network, the contribution-based segmentation software 32 produces links of value “zero” between every two customers, such that everyone is connected with everyone else. Then, for every time two customers make a transaction that is either the same (or is deemed the same by the contribution-based segmentation software 32 based on some defined level of similarly in transactions), a value of their link is incremented by a unit, e.g., “1” or alternatively by a measure that captures the size of the transaction. After the process has collected sufficient data (transactions) on the customers, the contribution-based segmentation software 32 removes all of the links whose value is zero or below a specified threshold.

Transactions can be deemed the same by the contribution-based segmentation software 32 for example, when the transactions involve the same security, but with substantially different volumes or when the transactions involve different securities, but which are of the same type, e.g., stocks vs. bonds, or when the transaction involves different securities of companies that are in the same general industry, e.g., purchases of stocks in automobile companies, etc.

Returning to the use case, in order to measure modularities, contribution-based segmentation software 32 subdivides the network into a number of groups (e.g., 10) by assigning an attribute to each customer (C) representing the group they belong to (i.e. a value between 1 and 10 in this use case). The contribution-based segmentation software 32 iteratively for each customer (C), assigns the customer, e.g., C₁ to a group Gᵢ (i.e., changes the value of the group attribute described above, measures the modularity Q of the whole network (call it M_{C1}-G₁), where C₁ represents customer 1 and G₁ represents group 1 and M_{C1} is the modularity of the network with customer 1 in Group 1), assigns the customer C₁ to a group G₂ and again measure the modularity of the whole network (call it MC₁−G₂, where C₁ represents customer 1 and G₂ represents group 2). Contribution-based segmentation software 32 iteratively follows the same process assigning the customer C₁ to each of the remaining ones of Gᵢ and does this for each customer Cᵢ. Once this process is applied to every customer (C) each customer (C) will have a Vᵢ vector of 10 modularities.

To accomplish segmentation, contribution-based segmentation software 32 calculates the distance between every two customers (C) using their vectors Vᵢ of modularities (e.g. a Euclidian distance calculation). Thereafter, using a clustering algorithm, contribution-based segmentation software 32 groups customers Cᵢ based on distance between them, i.e., customers who are closest to each other are most likely to belong to the same segment and thus can be considered similar for various purposes such as in this example as having similar investment behavior.

Many other use cases can use the above described process. For example, segments can be formed on financial institutions based on the loans they make, segments can be formed for securities, e.g., stocks based on the reliance of the underlying business on commodities and manufacturing in different parts of the world. Other use cases can involve segmentation of customers for product/offer placement.

Customer devices can be any sort of computing device capable of taking input from a customer and communicating over a network (not shown) with server and/or with other client devices. For example, customer device can be a mobile device, a desktop computer, a laptop, a cell phone, a private digital assistant (“PDA”), a server, an embedded computing system, a mobile device, as well as the eyeglasses, and so forth. Customer devices include a monitor device that renders the visual representations.

Server can be any of a variety of computing devices capable of receiving information, such as a server, a distributed computing system, a desktop computer, a laptop, a cell phone, a rack-mounted server, and so forth. Server may be a single server or a group of servers that are at a same location or at different locations.

Server can receive information from client devices via interfaces. Interfaces can be any type of interface capable of receiving information over a network, such as an Ethernet interface, a wireless networking interface, a fiber-optic networking interface, a modem, and so forth. Server also includes a processor and memory. A bus system (not shown), including, for example, an information bus and a motherboard, can be used to establish and to control information communication between the components of server.

Processor may include one or more microprocessors. Generally, processor may include any appropriate processor and/or logic that is capable of receiving and storing information, and of communicating over a network (not shown). Memory can include a hard drive and a random access memory storage device, such as a dynamic random access memory, machine-readable media, or other types of non-transitory machine-readable storage devices.

Components also include storage device, which is configured to store information such as the instruction code to implement the processes disclosed herein.

Embodiments can be implemented in digital electronic circuitry, or in computer hardware, firmware, software, or in combinations thereof. Apparatus of the invention can be implemented in a computer program product tangibly embodied or stored in a machine-readable storage device and/or machine readable media for execution by a programmable processor; and method actions can be performed by a programmable processor executing a program of instructions to perform functions and operations of the invention by operating on input information and generating output. The invention can be implemented advantageously in one or more computer programs that are executable on a programmable system including at least one programmable processor coupled to receive information and instructions from, and to transmit information and instructions to, an information storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and information from a read-only memory and/or a random access memory. Generally, a computer will include one or more mass storage devices for storing information files; such devices include magnetic disks, such as internal hard disks and removable disks; magneto-optical disks; and optical disks. Storage devices suitable for tangibly embodying computer program instructions and information include all forms of non-volatile memory, including by way of example semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

A number of embodiments of the invention have been described. Nevertheless, it will be understood that various modifications may be made without departing from the spirit and scope of the invention. For example, various measures of modalities and various clustering techniques could be used in addition to those mentioned above. The process could be applied to other subject domains. Accordingly, other embodiments are within the scope of the following claims.

1. A computer program product tangible stored on a computer readable device for contribution-based segmentation classification, comprises instructions for causing a processor to:
form a network structure that represents relationships among a set of entities;
produce a random partition of the set of entities into a fixed number of groups of entities;
then for each of a plurality of iterations:
sequentially associate each entity with each group; and
measure modularity for the network;
add the measured modularity to a vector of modularities for the respective entity using the groups as a base;
compute a distance between each of the entities using the modularity vectors;
form clusters of vectors according to the computed distance; and
segment the entities according the formed clusters.

2. The computer program product of claim 1 wherein the instructions to form the network structure uses explicit or implicit information of the entities and wherein the distance calculated is the Euclidean distance.

3. The computer program product of claim 1 wherein the fixed number of groups is based on a desired resolution.

4. The computer program product of claim 1 further comprising instructions to:
apply a configuration model to produce the initial random partition of the entities into the fixed number of groups of entities.

5. The computer program product of claim 1 further comprising instructions to:
iteratively associate the first entity in the first group with each of the succeeding groups; and
determine corresponding modularity for the network as the first entity is associated with each of the succeeding groups.

6. The computer program product of claim 1 wherein determining modularity further comprising instructions to:
compute modularity for the network as a function of a number of links within the group compared to a number of links out of the group.

7. The computer program product of claim 1 wherein modularity is a maximum when intra group links are at a maximum and inter group links are at a minimum.

8. The computer program product of claim 1 further comprising instructions to:
add the computed modularity for an entity to a vector of modularities for the entity using the groups as a base for values in the vector.

9. The computer program product of claim 1 wherein modularity is Newman's modularity, and the program further comprises instructions to:
compute a centroid for each computed cluster.

10. The computer program product of claim 1 wherein modularity is determined as a sum of links within a group minus an expected number of inner links inside the group minus outer links/degree.

11. A computer implemented method, the method comprising:
forming a network structure that represents relationships among a set of entities;
producing a random partition of the set of entities into a fixed number of groups of entities; then for each of a plurality of iterations:
sequentially associating each entity with each group; and
measuring modularity for the network;
adding the measured modularity to a vector of modularities for the respective entity using the groups as a base;
computing a distance between each of the entities using the modularity vectors;
forming clusters of vectors according to the computed distance; and
segmenting the entities according the formed clusters.

12. The method of claim 11 wherein forming the network structure uses explicit or implicit information of the entities and the distance calculated is the Euclidean distance.

13. The method of claim 11 wherein the fixed number of groups is based on a desired resolution.

14. The method of claim 11 further comprising:
applying a configuration model to produce the initial random partition of the entities into the fixed number of groups of entities.

15. The method of claim 11 further comprising:
iteratively associating the first entity in the first group with each of the succeeding groups; and
determining corresponding modularity for the network as the first entity is associated with each of the succeeding groups.

16. The method of claim 11 wherein determining modularity further comprises:
computing modularity for the network as a function of a number of links within the group compared to a number of links out of the group.

17. The method of claim 11 wherein modularity is a maximum when intra group links are at a maximum and inter group links are at a minimum.

18. The method of claim 11 further comprising:
adding the computed modularity for an entity to a vector of modularities for the entity using the groups as a base for values in the vector.

19. The method of claim 11 further comprising:
computing a centroid for each computed cluster.

20. The method of claim 11 wherein modularity is determined as a sum of links within a group minus an expected number of inner links inside the group minus outer links/degree.

21. A computer system comprising:
a processor;
memory coupled to the processor; and
a computer readable medium storing a computer program product for contribution-based segmentation classification, comprises instructions for causing the processor to:
form a network structure that represents relationships among a set of entities;
produce a random partition of the set of entities into a fixed number of groups of entities; then for each of a plurality of iterations:
sequentially associate each entity with each group; and
measure modularity for the network;
add the measured modularity to a vector of modularities for the respective entity using the groups as a base;
compute a distance between each of the entities using the modularity vectors;
form clusters of vectors according to the computed distance; and
segment the entities according the formed clusters.

22. The computer of claim 21 wherein the instructions to form the network structure uses explicit or implicit information of the entities and wherein the distance calculated is the Euclidean distance.

23. The computer claim 21 wherein the fixed number of groups is based on a desired resolution.

24. The computer of claim 21 wherein the program further comprises instructions to:
apply a configuration model to produce the initial random partition of the entities into the fixed number of groups of entities.

25. The computer of claim 21 wherein the program further comprises instructions to:
iteratively associate the first entity in the first group with each of the succeeding groups; and
determine corresponding modularity for the network as the first entity is associated with each of the succeeding groups.

26. The computer of claim 21 wherein determining modularity further comprising instructions to:
compute modularity for the network as a function of a number of links within the group compared to a number of links out of the group.

27. The computer of claim 21 further comprising instructions to:
compute a centroid for each computed cluster.
